(19) United States
(12) Patent Application Publication
(10) Pub. No.: US 2016/0291565 A1
(43) Pub. Date: Oct. 6, 2016

(54) AUTOMATION SYSTEM

(71) Applicant: SIEMENS AKTIENGESELLSCHAFT, München (DE)

(72) Inventor: Vitaliy VOLEVACH, Nürnberg (DE)

(21) Appl. No.: 15/037,244

(22) PCT Filed: Nov. 17, 2014
(86) PCT No.: PCT/EP2014/074787

§ 371 Date: May 17, 2016

(30) Foreign Application Priority Data
Nov. 19, 2013 (EP) 13005422.4

(51) Int. Cl. G05B 19/05

(52) U.S. Cl. CPC G05B 19/054; G05B 2219/1105

(57) ABSTRACT

An automation system which includes a first and a second controller for controlling an appliance or an installation, first and second input and/or output (I/O) units for receiving an electronic signal from the installation appliance or the installation and/or for outputting an electronic signal to the appliance or the installation, a control program which includes a plurality of control program modules for controlling the appliance or the installation, and a superordinate controller that associates the control program modules with the first and/or second controllers such that the appliance or the installation is controlled or can be controlled in accordance with the control program when the control program modules are executed within the respective control units, where the automation system is additionally configured such that each of the two control units interchange electronic data for controlling the appliance or the installation both with the first and with the second I/O units.

### CROSS-REFERENCE TO RELATED APPLICATIONS

This is a U.S. national stage of application No. PCT/EP2014/074787 filed 17 Nov. 2014. Priority is claimed on European Application No. 13005422 filed 19 Nov. 2013, the content of which is incorporated herein by reference in its entirety.

### BACKGROUND OF THE INVENTION

1. Field of the Invention

The present invention relates to an automation system having first and second controllers and first input and second input and/or output (I/O) units for controlling a device or an installation.

2. Description of the Related Art

A disadvantage of existing automation systems is that in the event of failure of a controller, either the entire control system fails until the failed controller has been replaced or, for example, each element of the automation system needs to have a redundant controller maintained for it in order to be able to ensure the functionality of the overall system in the event of failure of one of the components.

### SUMMARY OF THE INVENTION

In view of the foregoing, it is an object of the present invention to provide an automation system that can react more flexibly, more simply and/or better to changes within the automation system.

This and other objects and advantages are achieved in accordance with the invention by an automation system, a superordinate controller and a method in which the assignment of individual control program components, of which the control program for controlling the whole installation is made up, to different control units of the automation system allows flexible reaction to relevant changes for the control units or even for the input and/or output units. In this case, the first and/or the second controllers can correspond to a computer, to a module of a programmable logic controller or to a programmable logic controller (“PLC”) itself. In addition, the first and/or second I/O units may comprise an input and/or output (I/O) card for a computer or the like, an input and/or output module for a programmable logic controller or comparable modules or devices, for example.

The automation system may additionally also comprise more than two control units and/or I/O units, these each being able to be configured and set up based on the units presented in the present description.

The signals that are output by the I/O unit may be provided and configured to control one or more actuators of the controlled device or the controlled installation, for example. The received electronic signals may be provided and set up by appropriate sensors, or actuators of the controlled device or the controlled installation for the control unit, for example. In this case, the electronic signals may be analog voltage or current signals, analog signal trains or digital signals or signal trains, for example, or may consist of such signals.

The superordinate control unit may be configured and set up as a computer, a control unit, or a programmable logic controller or the like, for example.

The assignment of the control program components to the control units can be effected by transmission of the control program components from the superordinate control unit to the respective control units, for example. In addition, the assignment may also exist as a result of a piece of information about the control program components that are to be executed by the respective control units. Here, provision may be made, by way of example, for the respective control units to have already stored all or several of the control program components and, by virtue of the superordinate control unit, to obtain the information concerning which of the control program components are meant to be executed by them.

By way of example, a superordinate control unit may comprise a system that dynamically distributes control programs to connected control units and/or matches one or more control programs or components to corresponding control units, e.g. breaks them up into corresponding components, and/or also undertakes correct addressing of corresponding input and/or output channels.

By way of example, appropriate changes in the automation system may be omission and/or addition of control units, and/or I/O units or assemblies. In addition, changes in the automation system can also consist of a change of communication links, communication modules and similar modules or elements of the automation system, or can comprise such changes.

By way of example, impairment of control as a result of a change in the automation system may cause slower execution, more inaccurate execution and/or less reliable or more erroneous execution of the control program, or may consist of such. By way of example, control of the device to be controlled or of the installation to be controlled may become impossible if one of the control units involved fails, for example. In such a case, the superordinate control unit can then redistribute the control program components to the control units that are still functioning, for example.

By way of example, the check on the assignment of the control program components can be performed to determine whether the execution of the whole control program becomes slower, less reliable, more erroneous, impossible or similarly more negatively functional following a change in the automation system.

By way of example, the present invention can, in the event of failure of a programmable logic controller in the course of operation as a result of a hardware defect or another problem, help to obtain or restore a functionality more simply, less expensively and/or more quickly than is known from conventional systems.

Advantageously, the power supplies for the individual input or output assemblies can continue to be preserved in this case. In this case, it has hitherto been possible, by way of example, for a conventional installation to be re-started only after a failed component has been replaced and completely set up again. Alternatively, individual central units, for example, for conventional programmable logic controllers, may each have redundant or high-availability substitute central units provided for them that run in sync with the first and undertake the task thereof in the event of a fault. This is very expensive and complex, however, because more or less the entirety of the hardware needs to be duplicated.

The present invention solves this problem by using the superordinate control unit based on the present description. In one advantageous embodiment, when programmable logic controllers are used, each of the programmable logic controllers within the automation system can actuate each of the I/O units of the installation.

If the I/O units are appended to one or more of the programmable logic controllers, then they may be visible to and/or activable by other programmable logic controllers within a network (e.g., ProfiNet or ProfiBus). By way of example, this can be achieved by extending the functionality of the programmable logic controllers (for example, by using specific communication controllers) or by directly connecting input/output assemblies to a network (e.g., with a standalone controller in each case).

Advantageously, all the physical inputs and/or outputs are allocated a univocal address. This address allocation can be effected by an engineering system or by the superordinate control unit, for example. In this case, the automation system is advantageously refined, and set up, such that different inputs and/or outputs of an I/O unit can be written to or read by different instances of the control units or programmable logic controllers.

Advantageously, the respective I/O units may each be associated with control units of the automation system, or may be appended thereto. Here, the I/O units can then be connected to the respective control units via what is known as a backplane bus, as is regularly used, e.g., for what are known as programmable logic controllers. Here, the automation system, and particularly the backplane bus, may then be refined such that each of the I/O units is addressable, actuable or activable from each of the control units of the automation system. To this end, provision may be made, e.g., for each of the I/O units, and if need be also each of the control units, to obtain an address that is univocal in the automation system and via which it is reachable or activable.

To this end, the backplane bus may be set up and configured, e.g., such that it can be or is used to effect Transmission Control Protocol/Internet Protocol (TCP/IP) communication or communication based on the Internet protocol, particularly based on IPv4 and/or IPv6 if need be in addition to other communication options. In this way, it is possible to use, e.g., the mechanisms of the Internet protocol, particularly of IPv4 and/or IPv6 for the relevant address allocation. The communication among the control units and/also with the superordinate controller can likewise be effected using a communication protocol that is compatible with TCP/IP or the Internet protocol, particularly a correspondingly compatible field bus. Such communication may be designed and set up, e.g., based on the PROFINET standard or a comparable standard or protocol.

Advantageously, the control units and I/O modules may comprise modules or module combinations for modular programmable logic controllers (PLC).

In a further advantageous embodiment, the above-disclosed embodiments can be combined such that the automation system comprises modular programmable logic controllers that are connected to one another and to the superordinate controller via an IP-compatible network (e.g., ProfiNet) and that each comprise an IP-compatible backplane bus. In this way, the addressing of the individual modules of the automation system can be effected or simplified by the mechanisms of the Internet protocol (e.g. IPv4 and/or IPv6) if need be.

The superordinate controller “knows”, e.g., all programs, program components and/or control program components of an installation and can dynamically distribute them to the available control units or programmable logic controllers, e.g., inter alia can also program the memory units or programmable logic controllers. In this case, the sum total of the programs, program components or control program components is referred to within the present description as “the control program” for controlling the device or the installation.

The superordinate controller can also undertake the matching for the addressing in a program or corresponding program component or control program component so that, regardless of the executing control unit or programmable logic controller, for example, the correct I/O unit or assembly is always activated. In the event of a program change or failure of a control unit, a programmable logic controller or a corresponding control module, the superordinate control unit can then perform dynamic redistribution of the relevant programs, program components or control program components. In this case, the superordinate controller can comprise an optimization routine or an optimization program or an optimization module, for example, that is used to ascertain a split for the relevant program components that aims at uniform utilization of the controllers, for example. In addition, such an optimization routine or a corresponding module may be configured such that prescribed cycle times are observed in this case.

By way of example, the present invention is thus now used to program not a single control unit or programmable logic controller or CPU module of an automation system, as in conventional system but, rather, in principle, a cluster of control units or controllers. Allocation of programs or program components to the individual control units or programmable logic controllers or central modules is then undertaken by the superordinate controller, for example, by virtue of an appropriate optimizing algorithm provided therein.

In this case, one or more of the following advantages, inter alia, are obtained, (i) upgradability of existing automation solutions while retaining the original physical configuration of the controllers; (ii) more uniform program load distribution over all control units or programmable logic controllers networked for an installation; (iii) dynamic capability of performance extension for an installation through the addition of further control units or control modules without the need for an upgrade for the existing controllers; and (iv) Ni safety for the CPU of a composite system comprising programmable logic controllers. That is, when a control unit or a central module of a programmable logic controller fails, the installation continues to be in the operating state without a reserve needing to be individually maintained for each control unit or each central module.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below by way of example with reference to the appended drawings, in which:

FIG. 1 is a schematic block diagram of an exemplary automation system for controlling an installation in accordance with the invention;

FIG. 2 is a schematic block diagram of the automation system of FIG. 1 following failure of a controller;

FIG. 3 is a schematic block diagram of the automation system of FIG. 1 with alternative interfacing of the controlled installation; and

FIG. 4 is a flowchart of the method in accordance with the invention.

### DETAILED DESCRIPTION OF THE EXEMPLARY EMBODIMENTS

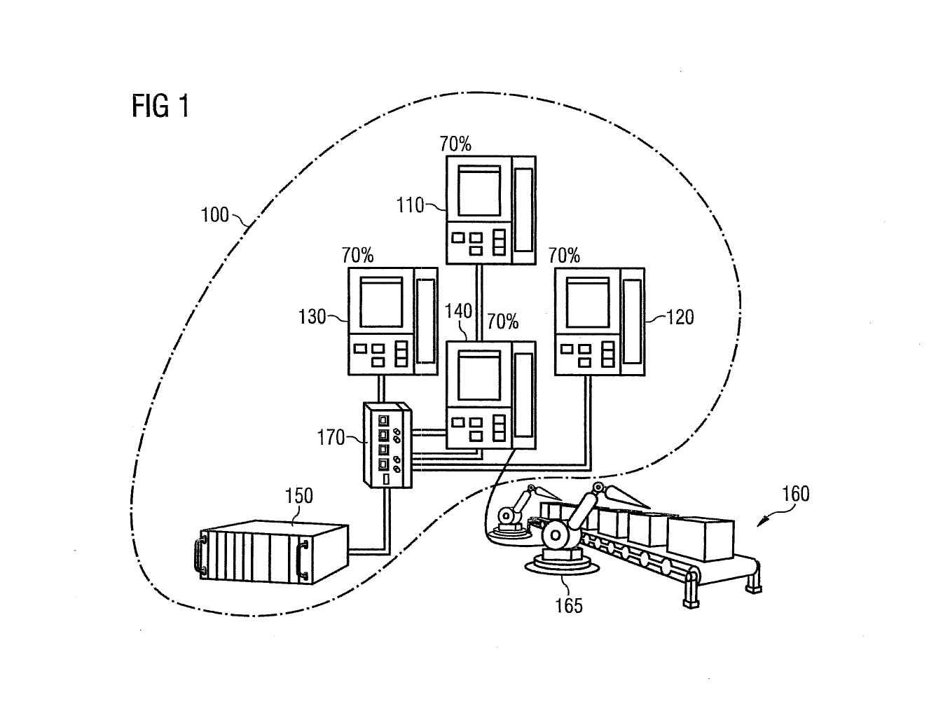

FIG. 1 shows an automation system 100 that consists of four programmable logic controllers 110, 120, 130, 140. Here, each of the programmable logic controllers (PLC) 110, 120, 130, 140 comprises a central unit and an input/output (I/O) module. The programmable logic controllers 110, 120, 130, 140 are each connected to one another and to what is known as a “dispatcher” 150 via a network node 170. In this case, the dispatcher is an example of a superordinate controller based on the present description.

The I/O assembly of the bottom PLC 140 in FIG. 1 is connected to a robot 165 in a controlled installation 160. Here, the robot 165 is controlled via appropriate input and output signaling from the I/O assembly of the bottom PLC 140.

To control the installation 160, various program components are provided that are transmitted from the dispatcher 150 to the PLCs 110, 120, 130, 140, and assigned, such that each of the PLCs 110, 120, 130, 140 is utilized to approximately 70% of its performance capability. In this case, the PLCs 110, 120, 130, 140 are refined such that each of the PLCs can also access each of the input/output assemblies of the other PLCs via the communication links shown in FIG. 1. By way of example, this can be effected by virtue of each of the PLCs 110, 120, 130, 140 comprising a communication module that also allows direct access to the input/output assembly of this PLC via the relevant communication link. Alternatively, it is also possible for the input/output assemblies to be equipped with an appropriate communication module or component, for example.

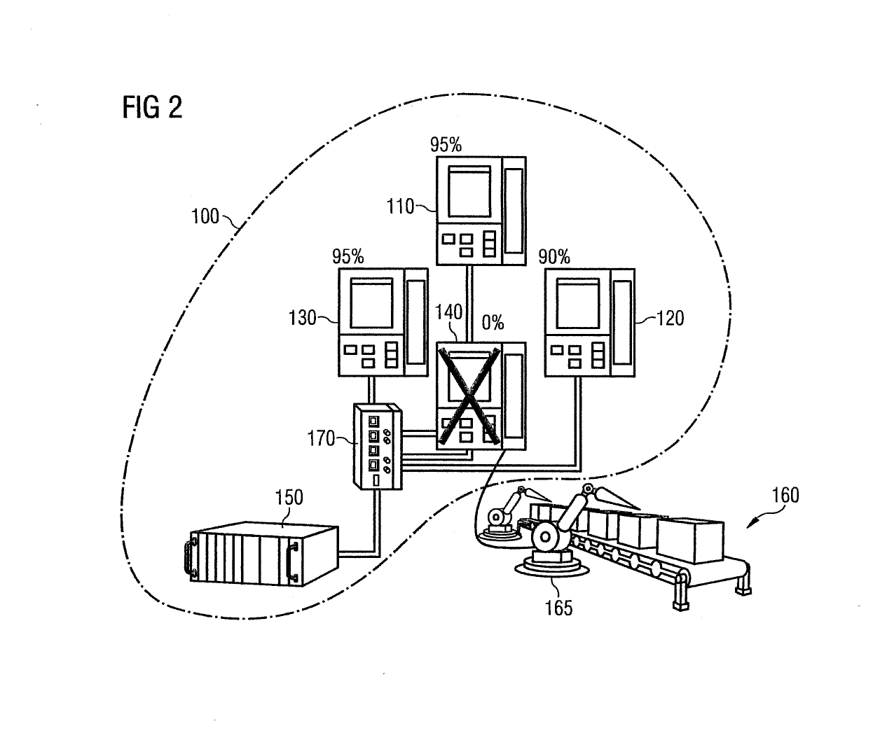

FIG. 2 shows the automation system 100 with the installation 160 connected thereto following failure of the bottom PLC 140. Following detection of this failure through the dispatcher 150 or following an appropriate piece of information to the dispatcher 150, the dispatcher 150 undertakes redistribution of all program components that are necessary for controlling the installation 160 to the remaining functioning PLCs 110, 120, 130. In so doing, the dispatcher 150 ascertains a program distribution such that none of the connected PLCs 110, 120, 130 that are still functioning is overloaded. Thus, in the present example, a redistribution of the necessary program components by the dispatcher 150 is obtained such that two of the PLCs 110, 130 are utilized to 95% and the third, 120, is utilized to 90%.

The robot 165 continues to be actuated via the I/O assembly of the faulty PLC 140, where the signals to this I/O assembly are transmitted to this I/O assembly from those of the remaining PLCs 110, 120, 130 that now comprise appropriate program components for controlling the robot 165.

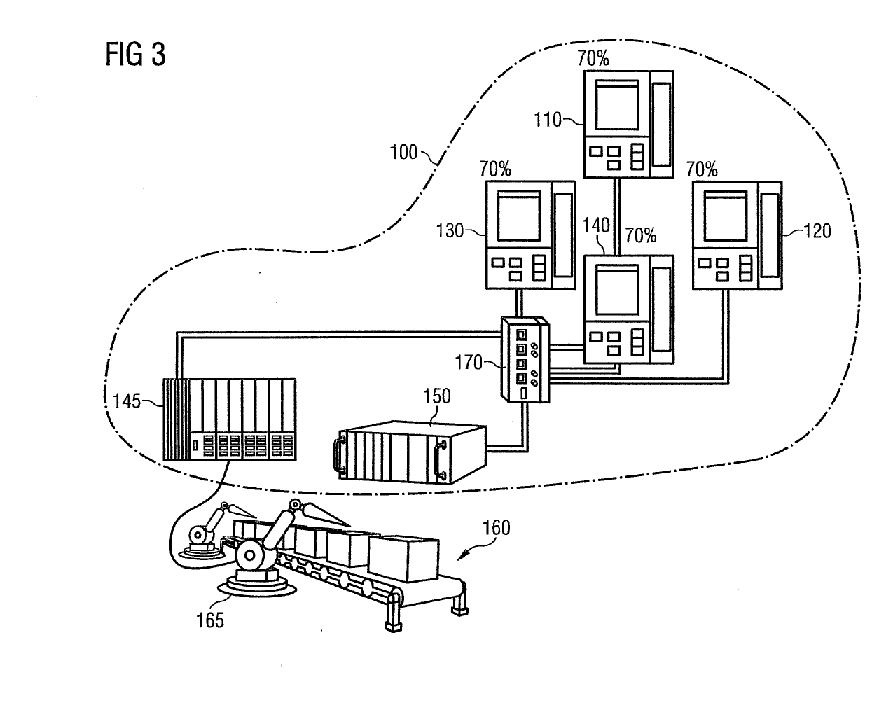

FIG. 3 shows an alternative embodiment of the automation system 100 for controlling the installation 160 to the representation in FIG. 1. In this case, besides the PLCs 110, 120, 130, 140 already represented in FIG. 1, a local peripheral unit 145, which comprises multiple input/output assemblies and is connected to the network node 170 and via the later also to the PLCs 110, 120, 130, 140 of the dispatcher 150, is also provided. Here, the assemblies of the local peripheral unit 145 are actuable or readable from any of the PLCs 110, 120, 130, 140.

In the case of the system represented in FIG. 3, the installation 160 is now actuated via the local peripheral unit 145. Here, the robot 165 is particularly controlled via an assembly of the local peripheral unit 145.

As already explained in the case of the automation system 100 represented in FIG. 1, in order to control the installation 160, various program components that are transmitted from the dispatcher 150 to the PLCs 110, 120, 130, 140, and assigned, such that each of the PLCs 110, 120, 130, 140 is utilized to approximately 70% of its performance capability, are provided in this case too.

In the event of failure of the bottom PLC 140, for example, the dispatcher 150 undertakes, in a manner similar to the case already explained in connection with FIG. 2, redistribution of all program components that are necessary for controlling the installation 160 to the remaining functioning PLCs 110, 120, 130. Here, the dispatcher 150 ascertains a program distribution such that none of the connected, still functioning PLCs 110, 120, 130 is overloaded. Thus, in the present example, it is in turn possible for a redistribution of the necessary program components by the dispatcher 150 to be obtained such that two of the PLCs 110, 130 are utilized to 95% and the third, 120, is utilized to 90%; again in accordance with the exemplary embodiment represented in FIG. 2.

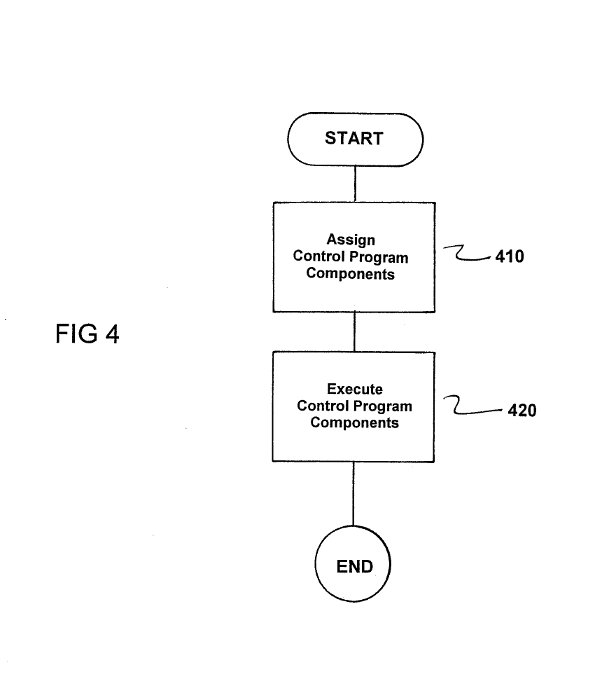

In this case, the robot 165 continues to be actuated without alteration via the assembly of the local peripheral unit 145. FIG. 4 is a flowchart of the method for operating an automation system (100). The method comprises assigning, by a superordinate controller (110, 120, 130, 140, 150), control program components to at least one of first and second controllers (110, 120, 130, 140), as indicated in step 410. Next, the control program components are executed within at least one of the first and second controllers (110, 120, 130, 140) such that a device (165) to be controlled by the automation system (100) or the installation (160, 165) to be controlled is controlled based on a control program, as indicated in step 420.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. An automation system comprising:
a first controller and a second controller for controlling a device or an installation;
a first input and/or output (I/O) unit and a second I/O unit for at least one of (i) receiving an electronic signal from the device or the installation and (ii) outputting an electronic signal to the device or the installation, and
a control program comprising multiple control program components, for controlling the device or the installation; and
a superordinate controller configured to assign the control program components to at least one of the first and second controllers such that the device or the installation is controlled or is controllable in accordance with the control program when the control program components are executed within a respective controller of the first and second controllers;
wherein the automation system is configured such that each of the first and second I/O units interchange electronic data for controlling the device or the installation with the first and second I/O units.

15. The automation system as claimed in claim 14, wherein the first and second I/O units each have an associated communication module for communication with at least one of the first and second controllers.

16. The automation system as claimed in claim 14, wherein the superordinate controller is configured to check the assignment of the control program components to the first and second control units in an event of a change in the automation system.

17. The automation system as claimed in claim 15, wherein the superordinate controller is configured to check the assignment of the control program components to the first and second control units in an event of a change in the automation system.

18. The automation system as claimed in claim 16, wherein the superordinate controller is configured to change the assignment of the control program components to the first and second controllers following the check in the event of a change in the automation system;
wherein the assignment is changed when the result of the check indicates control of the device or installation is one (i) impaired and (ii) becomes impossible with an existing assignment of the control program components as a result of the change in the automation system.

19. The automation system as claimed in claim 14, wherein the first and second input I/O units are each appended to at least one of the first and second controllers; and wherein the first and second I/O units are at least one of (i) visible to, (ii) activable and (iii) actuable by each of the first and second controllers.

20. The automation system as claimed in claim 19, wherein the first and second I/O units are each connected to a respective control unit, to which they are appended, via a backplane bus;
wherein the backplane bus is configured, and set up, such that each of the first and second I/O units is at least one of (i) addressable and (ii) activable from each of the first and second controllers.

21. The automation system as claimed in claim 20, wherein communication via the respective backplane buses is based on at least one of Transmission Control Protocol/Internet Protocol and (ii) an Internet protocol based on IPv4 or IPv6.

22. The automation system as claimed in claim 14, wherein the first and second I/O units and at least one of the first and second controllers each comprise modules or module combinations of a modular programmable logic controller.

23. A method for operating an automation system, comprising
assigning, by a superordinate controller, control program components to at least one of first and second controllers;
executing the control program components within at least one of the first and second controllers such that a device to be controlled by the automation system or the installation to be controlled is controlled based on a control program.

24. The method as claimed in claim 23, wherein the superordinate controller checks the assignment of the control program modules to the first and second control units in the event of a change in the automation system.

25. The method as claimed in claim 24, wherein the assignment of the control program modules to the first and second control units is changed by the superordinate control unit if the result of the check is a nonfunctionality or an impaired functionality of the control of the device or the installation based on the control program as a result of the change in the automation system.

26. A superordinate controller for an automation system,
wherein the superordinate controller is configured to:
assign control program components to at least one of first and second controllers such that a device or an installation is controlled or is controllable in accordance with a control program when the control program components are executed within a respective controller of the first and second controllers; and
wherein the automation system is configured such that each of a first input and/or output (I/O) unit and a second I/O unit interchange electronic data for controlling the device or the installation with the first and second I/O units.

27. The superordinate control unit as claimed in claim 25, wherein the superordinate controller is further configured to:
execute the control program components within at least one of the first and second controllers such that a device to be controlled by the automation system or the installation to be controlled is controlled based on a control program.
